(19) United States
(12) Patent Application Publication
(10) Pub. No.: US 2019/0377064 A1
(43) Pub. Date: Dec. 12, 2019

(54) METHOD AND APPARATUS FOR DEICING OF SENSOR SYSTEMS IN A VEHICLE

(71) Applicant: GM GLOBAL TECHNOLOGY OPERATIONS LLC, Detroit, MI (US)

(72) Inventors: Alyssa L. Scheske, Ann Arbor, MI (US); Andrew Wassef, Rochester, MI (US); Tessa E. Elwart, Ann Arbor, MI (US)

(21) Appl. No.: 16/001,543

(22) Filed: Jun. 6, 2018

(51) Int. Cl. G01S 7/40; G01S 7/497; G01S 13/93; G01S 17/93

(52) U.S. Cl. CPC G01S 7/40; G01S 7/497; G01S 13/931; G05D 1/0231; G01S 2007/4047; G01S 2007/4977; G01S 17/936

(57) ABSTRACT

Methods and systems are provided for controlling a radar system in a vehicle. In particular, the method and system employs a heating element within or affixed to a portion or proximate to a vehicular radar sensor and where the method and system is operative to determine that a blockage of the vehicular radar sensor has occurred and that an icing condition may exist, and to activate the heating element in response.

### TECHNICAL FIELD

The present disclosure generally relates to vehicular sensor systems for active vehicle control, and more particularly relates to methods and apparatuses for detection of ice buildup on vehicular radar systems and removal thereof.

### BACKGROUND

Autonomous vehicles and active safety systems in vehicles use a number of vehicular sensors to locate objects around them, such as radar, lidar, and cameras. However, during cold weather conditions, vehicular sensors may become covered with ice and become inoperable or have serious operational degradation. Vehicle sensors are often placed in front facias of vehicles and close to the road surface, making ice buildup a likely occurrence. In addition, as vehicles become more complex, a driver may not be able to diagnose problems and clear sensors manually. It would be desirable to enable the sensors to self-clear to overcome the previously described problems and enable vehicular sensors, such as radar sensors, during freezing conditions.

### SUMMARY

A method and system are disclosed herein for controlling one or more field of view sensors in a vehicle. In various embodiments, a controller is programmed and equipped in hardware, i.e., configured, to process dynamic input information, which may be driver-requested and/or autonomously-determined values to determine a sensor blockage, and in particular, a sensor blockage due to ice buildup, and to autonomously clear this ice buildup. In this manner, the controller is able to determine an active vehicle system error, detect a sensor blockage, clear the sensor blockage, and reenable the active vehicle system.

In an exemplary embodiment, a method is disclosed for deicing of vehicle sensor systems in a vehicle comprising generating a first control signal to activate a sensor, receiving a first error signal indicating a failure of the sensor to activate, generating a second control signal to activate a heating element integrated proximate to the sensor, receiving a data indicating an activation of the sensor, and controlling a vehicle system in response to the data.

In another exemplary embodiment, an apparatus is disclosed for deicing of vehicle sensor systems in a vehicle comprising a sensor for transmitting and receiving a sensor signal and for generating a data in response to the sensor signal, the sensor further operative to generate a first error signal in response to an error condition, a heating element proximate to the sensor, and a vehicle controller for controlling a vehicle system in response to the data, a sensor controller for generating a first control signal to activate the sensor, for receiving the data, for receiving the first error signal, for generating a second control signal to activate the heating element integrated proximate to the sensor, and for coupling the data to the controller.

The above described and other features and advantages of the present disclosure will be readily apparent from the following detailed description of the embodiments and best modes for carrying out the described disclosure when taken in connection with the accompanying drawings and appended claims.

### DESCRIPTION OF THE DRAWINGS

The present disclosure will hereinafter be described in conjunction with the following drawing figures, wherein like numerals denote like elements, and wherein:

FIG. 1 is an illustrative view of an applications of a vehicle sensor system, in accordance with an exemplary embodiment.

FIG. 2 an illustrative view of a vehicle sensor system employing ice mitigation, in accordance with an exemplary embodiment.

FIG. 3 an illustrative view of a vehicle sensor system employing ice mitigation, in accordance with another exemplary embodiment.

FIG. 4 shows an exemplary method for ice mitigation in a vehicle sensor system, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

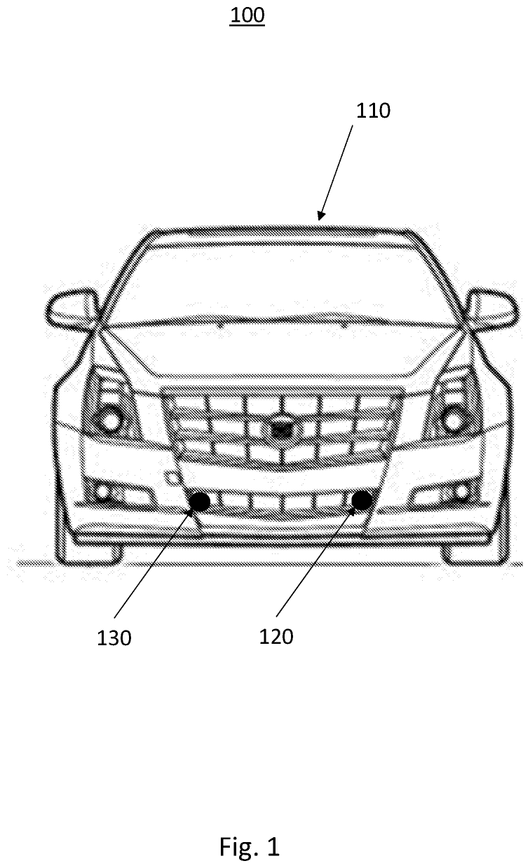

FIG. 1 provides an illustrative view of a plurality of exemplary applications of ice mitigation in a vehicle radar system 100. A vehicle 110 is shown employing a vehicular radar system. The vehicular radar system employs at least one radar sensor 120 which transmits and receives a radar plus at a known frequency. The radar sensor 120 to transmit a series of electromagnetic pulse, receive a reflection of each of the electromagnetic pulses, and compares the amplitude, phase and frequency of the transmitted and received pulses to determine the distance, velocity, and/or acceleration of an object with a field of view of the radar sensor. Typically, a vehicular radar sensor with have a horizontal field of view of +/−5-10 degrees. Vehicular radar can be used for autonomous vehicle control, predictive braking systems, adaptive cruise control, evasive steering control and the like.

In addition, the vehicle 110 may employ a lidar sensor for transmitting and receiving light pulses. The present exemplary embodiments described the proposed method and systems in accordance with a radar transmitter, but the method and systems are not limited to radar alone. The methods and system may be applied to a lidar sensor, a camera, or any vehicular sensor system where ice buildup may result in system degradation. The sensor may be protected by a protective cover, such as a transparent protective cover for a camera, a lens or transparent cover for a lidar and a radome for a radar.

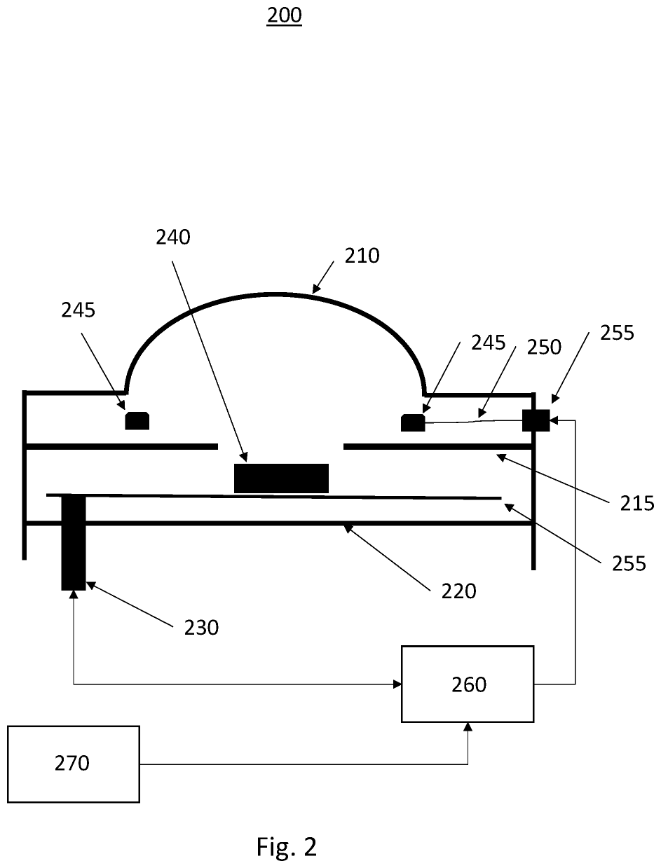

With reference to FIG. 2, an illustrative view of a vehicular radar sensor 200 according to an exemplary embodiment t is shown. The vehicular radar sensor 200 includes a radome 210, an upper housing 215, a lower housing 220, a printed circuit board 255 having at least one radar transmit/receive antenna 245 and signal processing and power supply circuitry. The vehicular radar sensor 200 also has a connector 230 or interface for transmitting data to a vehicle control module 260. In this first exemplary embodiment, the vehicular radar sensor also has at least one resistive heating element 245 housed between the upper housing 215 and the radome 210. The resistive heating element 245 is coupled to a connector 255 via a wire 250 to a vehicle control module 260. A sensor 270 is coupled to the vehicle control module 260.

The radar transmit/receive antenna 245 is operative to transmit and receive the radar pulses. The radar pulses can be frequency modulated radio frequency signals transmitted for a known duration. If the same antenna is used for transmitting and receiving the radar pulses, a switch is used to first couple the transmitter to the antenna 245 for the duration of the pulse, and then switch the antenna to the receiver path for receiving the reflected signal and coupling the reflected pulse to the receive circuitry and processor. The radome 210 is a protective structure made of dielectric materials that are essentially transparent to the transmitted and received radar pulse. For example, a radome 210 can be fabricated from fiberglass or polyurethane. The radome protects the antenna 240, the printed circuit board 255 and related circuitry from damage from water, ice, or debris.

The upper housing 215 is a metallic structure with an aperture to allow propagation of the radar pulse from the antenna to the radome and out into the field of view. The upper housing is another protective and structural element of the vehicular radar sensor 200 and is used primarily to protect the circuitry on the printed circuit board. The lower housing 220 forms the back side of the protective enclosure and is fabricated with a protective seal for providing a weather tight seal between the upper housing 215 and the lower housing 220. The printed circuit board 255 having at least one radar transmit/receive antenna 240 and signal processing and power supply circuitry is housed between the upper housing 215 and the lower housing 220. The printed circuit board 255 is connected to the vehicle control module 260 via a connector 230 which couples analog signals, digital data and power supply lines though the lower housing 230 in this exemplary embodiment.

A problem with traditional vehicular radar sensors in this configuration is that ice may build up on the radome 210, thereby degrading signal quality and amplitude when passing through the radome 210 and ice. In this first exemplary embodiment, the vehicular radar sensor also has at least one resistive heating element 245 housed between the upper housing 215 and the radome 210. The resistive heating element 245 is coupled to a connector 255 via a wire 250 to a vehicle control module 260. When the resistive element is engaged, the air inside the radome 210 is heated, and some of this heat is transferred through the radome 210. This has the advantageous effect of melting an inner layer of ice covering the radome 210, thereby preventing ice buildup and allowing any built up ice to fall off of the radome 210. The resistive element 245 may form a complete loop around the aperture in the upper housing 215.

Deicing the radome 210 on a vehicular radar sensor 200 allows important active safety features to be available during snowy and icy weather conditions. This may result in better customer satisfaction, as without the proposed system the driver must exit the vehicle to clear ice/snow blockage themselves, possibly damaging the sensor, the vehicle, or themselves. The proposed system utilizes the radar sensor 200 status signals transmitted on serial bus to implement a conditional heater. For example, if the ambient temperature is below certain threshold, the windshield system detects moisture and LRR blockage is identified, the heater will run similarly to the current rear windshield defroster systems and the windshield wipers' rain detect system.

The vehicle control module 260, such as an External Object Calculating Module, may be used as a central control module for active safety features the vehicle control module 260 may be used to manage the conditional use of the resistive heating element 245 in response to a humidity or moisture measurement, a radar blockage error, and/or outside ambient temperature. The outside ambient temperature may be determined in response to the sensor 270 being a temperature sensor and providing temperature data to the vehicle control module 260. Likewise, the sensor 270 may be a humidity sensor, a rain sensor, or the like.

In an alternative embodiment, the radome may be replaced by a transparent protective cover, and the radar transmit/receive antenna 240 may be replaced with a lidar transmitter and detector. Likewise, the radar transmit/receive antenna 240 may be replaced with a camera and the radome 210 with a lens or transparent protective covering.

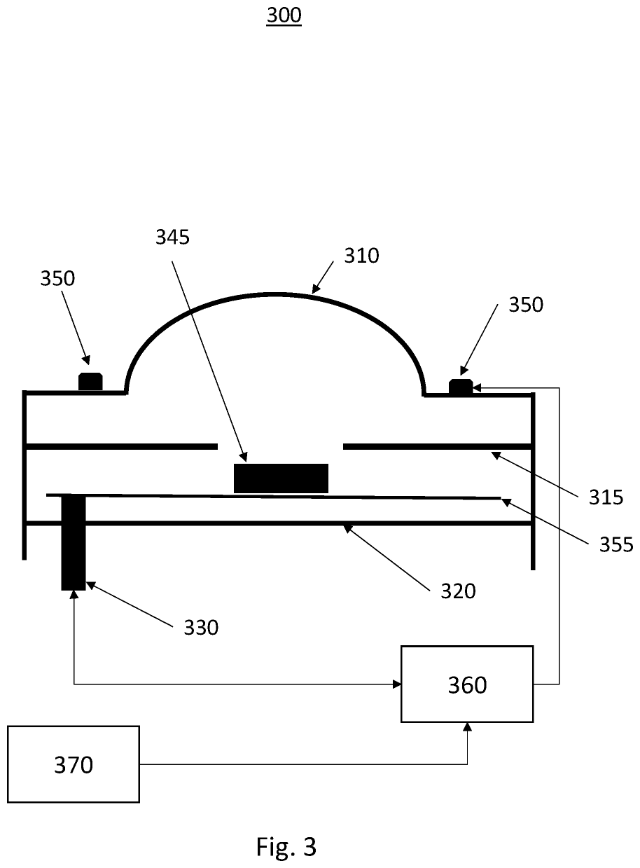

Turning not of FIG. 3, an illustrative view of a vehicular radar sensor 300 according to another exemplary embodiment is shown. The second exemplary vehicular radar sensor 300 includes a radome 310, an upper housing 315, a lower housing 320, a printed circuit board 355 having at least one radar transmit/receive antenna 345 and signal processing and power supply circuitry. The vehicular radar sensor 300 also has a connector 330 or interface for transmitting data to a vehicle control module 360. In this second exemplary embodiment, the vehicular radar sensor also has at least one heating element 350 housed to the outside of the radome 310 outside of the field of view of the radar transmit/receive antenna 345. The heating element 350 is coupled to vehicle control module 360 for control of the heating element cycling in response to a humidity or moisture measurement, a radar blockage error, and/or outside ambient temperature. A sensor 370 may also be coupled to the vehicle control module 360. In an exemplary embodiment, the sensor 370 may be a temperature sensor for determining the outside ambient temperature.

In an alternate embodiment, the heating element may be activated in response to a command from the key fob. For example, if a user initiates a remote vehicle startup, the system may turn on the heating element for a duration of time. Optionally, the system may determine the outside temperature from data from the sensor 370, determine that icing conditions may occur, and then activate the heating element if icing conditions are possible. Heating the radome 310 and antenna 345 may have the added benefit of clearing any frost or condensation before the sensing system is put into use, thereby improving performance.

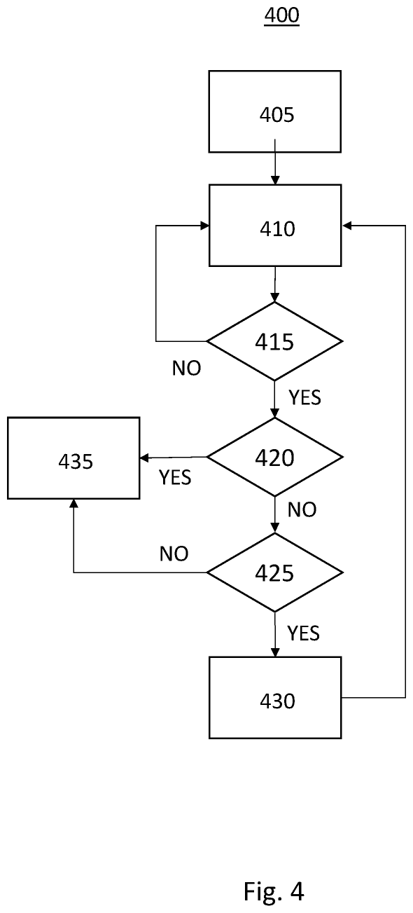

With reference to FIG. 4, an exemplary method for ice mitigation in a vehicular radar system 400 according to an exemplary embodiment is shown. The method is first operative to initiate the vehicular radar system 405 at vehicle startup. The vehicle radar system may be part of at least one active safety system, such as a collision avoidance system or the like. Alternatively, the vehicle radar system may be initialized when the vehicle transmission is placed into drive, or when the vehicle reaches a threshold speed, such as five miles per hour for example.

The method is then operative to operate the vehicle radar system 410 and monitor for system performance 415. If an error with the vehicle radar system is detected 415 indicating a radar sensor blockage or the like, the method may then be operative to determine if a deicing process has been previously initiated 420. In an exemplary embodiment, the method may be limited to attempting the deicing processes one time or cycle, or a predetermined number of cycles. If, after the predetermined number of cycles have been performed and the blockage is still not cleared, it may be assumed that the blockage has not occurred due to ice and may be another material, such as mud. Alternatively, the ice may be thick enough that it cannot be dislodged by the heating process. If the deicing process has been previously initiated 420, or alternatively, the heating process has been cycled the predetermined number of times, the method may then be operative to generate an error signal 435 and couple this error signal to a vehicle controller, or the like, and/or to a user interface for informing the user that the radar system, or the active safety device, is not operational. When generating the error system, the radar sensor my optionally be disabled, the transmission capabilities disabled, or the radar sensor may remain enabled in a reduced power state.

If a predetermined number of cycles have not been attempted 420, the method may then be operative to determine an outside ambient temperature 425 to determine if icing conditions or a freezing condition may exist. For example, if the ambient temperature is twenty five degrees Celsius, a freezing condition is unlikely and the vehicle radar sensor is likely blocked for a different reason, such as foreign object or structural damage, for example. However, if the ambient temperature is five degrees Celsius, a freezing condition may exist and the method would attempt the heating cycle. If the method does not determine that a freezing condition may exist, the method is operative to generate an error signal or the like to a vehicle control system 435. The error signal may indicate to the vehicle control system that the vehicle radar system is blocked and that repair or user intervention is required. The vehicle control system may also affect changes to the operation of the vehicle to compensate for the disabled vehicle radar system. If the method is operative to determine that a freezing condition may exist 425, the method may then activate the heating element for predetermined time duration and, optionally increment a cycle counter 530. The method is then operative to return to operating the vehicle radar system 410 and monitoring vehicle radar system performance 415. The predetermined time duration may be a fixed time, such as 1 minute, or may be variable depending on factors such as temperature, humidity, traction control, or the like. Alternatively, the method may be operable to detect a temperature conducive to an icing condition and leave the heating element activated for the duration of the activation of the vehicular radar system. The heater may be activated until the blocked condition is determined cleared.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof

What is claimed is:

1. A method comprising:
generating a first control signal to activate a sensor;
receiving a first error signal indicating a failure of the sensor to activate;
generating a second control signal to activate a heating element integrated proximate to the sensor;
receiving a data indicating an activation of the sensor; and
controlling a vehicle system in response to the data.

2. The method of claim 1 wherein the sensor is a radar antenna.

3. The method of claim 1 wherein the sensor is a radar antenna having a radome, and wherein the heating element is located within the radome.

4. The method of claim 1 wherein the heating element is activated for a duration of time.

5. The method of claim 1 further comprising deactivating the heating element in response to receiving the data indicating the activation of the sensor.

6. The method of claim 1 wherein the generating of the second control signal is made in response to a temperature measurement indicating a freezing condition may exist.

7. The method of claim 1 further comprising generating a second error signal indicative of a failure of the sensor to activate and a temperature measurement indicating a freezing condition may not exist.

8. The method of claim 1 further wherein the generating of the second control signal is made in response to a humidity measurement indicating an icing condition may exist.

9. The method of claim 1 wherein the first control signal is generated in response to starting a vehicle.

10. The method of claim 1 wherein the method is performed by a vehicle controller in a vehicle.

11. An apparatus comprising:
a sensor for transmitting and receiving a sensor signal and for generating a data in response to the sensor signal, the sensor further operative to generate a first error signal in response to an error condition;
a heating element proximate to the sensor;
a vehicle controller for controlling a vehicle system in response to the data; and
a sensor controller for generating a first control signal to activate the sensor, for receiving the data, for receiving the first error signal, for generating a second control signal to activate the heating element integrated proximate to the sensor, and for coupling the data to the controller.

12. The apparatus of claim 11 wherein the sensor is a radar antenna.

13. The apparatus of claim 11 further comprising a radome covering the sensor and wherein the heating element is located within the radome.

14. The apparatus of claim 11 wherein the heating element is activated for a duration of time.

15. The apparatus of claim 11 wherein the heating element is activated for a duration of time and wherein the duration of time is at least one minute.

16. The apparatus of claim 11 further comprising a lens and wherein the sensor is a lidar and the heating element is located between the lens and the lidar.

17. The apparatus of claim 11 further comprising a transparent protective cover and wherein the sensor is a lidar and the heating element is located between the transparent protective cover and the lidar.

18. The apparatus of claim 11 further comprising a humidity sensor and wherein the second control signal is generated in response to a humidity measurement indicating an icing condition may exist.

19. The apparatus of claim 11 further comprising a temperature sensor and wherein the second control signal is generated in response to a temperature sensor indicating a temperature indicative of a freezing condition.

20. The apparatus of claim 11 further comprising a user interface for indicating a failure mode in response to a failure control signal and wherein the sensor processor is further operative to generating the failure control signal in response to not receiving the data.
